(19) United States
(12) Patent Application Publication
(10) Pub. No.: US 2025/0291332 A1
(43) Pub. Date: Sep. 18, 2025

(54) CONTROL DEVICE, MACHINE TOOL, AND CONTROL METHOD

(71) Applicant: FANUC CORPORATION, Minamitsuru-gun, Yamanashi (JP)

(72) Inventor: Yuuta IMAMATSU, Minamitsuru-gun, Yamanashi-ken (JP)

(73) Assignee: FANUC CORPORATION, Minamitsuru-gun, Yamanashi (JP)

(21) Appl. No.: 18/862,697

(22) PCT Filed: May 12, 2022
(86) PCT No.: PCT/JP2022/020029

§ 371 Date: Nov. 4, 2024

(51) Int. Cl. G05B 19/4065; B23Q 11/00; B23Q 11/10

(52) U.S. Cl. CPC G05B 19/4065; B23Q 11/0046; B23Q 11/10; G05B 2219/49052

(57) ABSTRACT

A control device for a machine tool, which machines a workpiece in a processing area and is equipped with a coolant supplier that supplies coolant to the processing area and a mist collector that collects mist within the processing area, comprises a machining control unit that controls the machine tool to perform machining on the basis of a machining program and determines whether the machining has finished, and a collector control unit that automatically stops the mist collector if the machining has finished.

### TECHNICAL FIELD

The present invention relates to a control device, a machine tool, and a control method.

### BACKGROUND ART

A mist collector collects mist generated within a machining area of a machine tool (refer also to JP 2012-076006 A). The mist collector collects the mist within the machining area, and prevents the mist from leaking out to the exterior of the machining area. The mist is a coolant of fine or minute particles that are suspended within the air.

### SUMMARY OF THE INVENTION

In order to reliably prevent the mist from leaking out to the exterior of the machining area, the mist collector is often operated over a prolonged time period. However, the mist collector, by being operated over a prolonged time period, consumes a large amount of electrical power.

An object of the present invention is to solve the aforementioned problem.

A first aspect of the present invention is a control device for a machine tool including a coolant supply device configured to supply a coolant to a machining area, and a mist collector configured to collect mist within the machining area, the machine tool being configured to machine a workpiece within the machining area, the control device including a machining control unit configured to control the machine tool to carry out machining based on a machining program, and configured to determine whether or not the machining is completed, and a collector control unit configured to automatically stop the mist collector in a case that the machining is completed.

A second aspect of the present invention is a machine tool including the control device according to the first aspect.

A third aspect of the present invention is a control method for controlling by a computer a machine tool including a coolant supply device configured to supply a coolant to a machining area, and a mist collector configured to collect mist within the machining area, the machine tool being configured to machine a workpiece within the machining area, the control method including an end determination step in which the computer determines whether or not machining is completed based on a machining program, and a stop control step in which the computer controls the mist collector, and causes the mist collector to be automatically stopped in a case that the machining is completed.

In accordance with such features, it is possible to suppress the electrical power consumption of the mist collector.

### BRIEF DESCRIPTION OF DRAWINGS

FIG. 1 is a schematic diagram of a machine tool according to an embodiment;

FIG. 2 is a block diagram of a control device;

FIG. 3 is a flowchart illustrating a control method according to the embodiment;

FIG. 4 is a schematic diagram of a machine tool according to an exemplary modification 1; and

FIG. 5 is a block diagram of a control device according to an exemplary modification 2.

### DETAILED DESCRIPTION OF THE INVENTION

### Embodiment

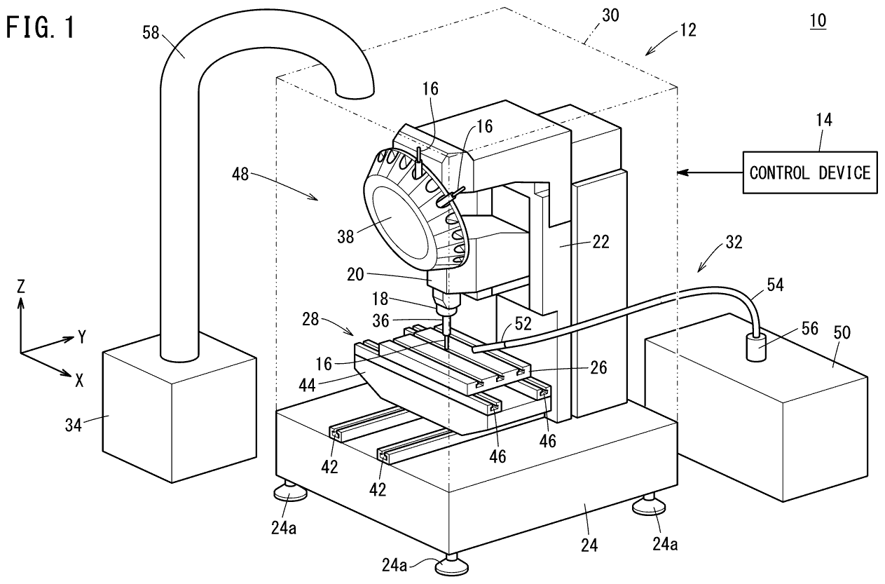

FIG. 1 is a schematic diagram of a machine tool 10 according to an embodiment.

The X direction and the Y direction shown in FIG. 1 are directions that are parallel to a horizontal plane. The X direction and the Y direction are mutually orthogonal with each other. The Z direction shown in FIG. 1 is a direction that is parallel to the direction of gravity. Accordingly, the Z direction is perpendicular to the X direction and the Y direction. However, the Z direction shown in FIG. 1 indicates a direction that is opposite to the direction of gravity.

The machine tool 10 includes a machining device 12 and a control device 14.

The machining device 12 is a machine that carries out machining on a workpiece using a tool 16. The machining device 12 is equipped with a spindle 18, a spindle head 20, a column 22, a pedestal 24, a table 26, a table drive unit 28, a cover 30, a coolant supply device 32, and a mist collector 34.

A tool holder 36 is attached to the spindle 18 (refer to FIG. 1). The tool holder 36 is capable of being attached and detached to and from the spindle 18. The tool holder 36 retains the tool 16. The tool 16, for example, is a spring-necked turning tool, a drill, an end mill, a milling cutter, or the like.

The machining device 12 is further equipped with a tool magazine 38. The tool magazine 38 detachably retains a plurality of the tools 16. One of the plurality of the tools 16 that are retained in the tool magazine 38 is changeably attached to the tool holder 36.

The spindle head 20 supports the spindle 18. Further, the spindle head 20 includes a motor that causes the spindle 18 to be rotated. The tool 16, which is attached to the spindle 18 via the tool holder 36, rotates together with the spindle 18.

The column 22 supports the spindle head 20. Further, the column 22 includes a motor that causes the spindle head 20 to be moved in the Z direction. The column 22 is supported on the pedestal 24.

The pedestal 24 is installed on an installation surface. The installation surface, for example, is a floor of a factory. The installation surface may be a support surface of a platform that is provided on the floor. The installation surface extends, for example, parallel to the horizontal plane. The pedestal 24 may be equipped with a plurality of leg members 24a. Each of the leg members 24a, for example, may be a caster, a jack, or the like.

The table drive unit 28 is supported on the pedestal 24. The table drive unit 28 is equipped with a first slide unit 42, a saddle 44, and a second slide unit 46.

The first slide unit 42 is installed on the pedestal 24. The first slide unit 42 includes, for example, guide rails that extend in the Y direction. The first slide unit 42 supports the saddle 44.

The saddle 44 moves in the Y direction in accordance with the driving of a non-illustrated motor. The motor is controlled by the control device 14. The saddle 44 moves while being guided by the first slide unit 42. A more detailed description of the control device 14 will be presented later.

The second slide unit 46 is provided on the saddle 44. The second slide unit 46 includes, for example, guide rails that extend in the X direction.

The table 26 supports a non-illustrated workpiece downwardly of the spindle 18. The table 26 is supported on the second slide unit 46. The table 26 moves in the X direction in accordance with the driving of a non-illustrated motor. The motor is controlled by the control device 14. The table 26 moves while being guided by the second slide unit 46.

The cover 30 covers the spindle 18, the spindle head 20, the column 22, the pedestal 24, the table 26, and the table drive unit 28. Consequently, the cover 30 forms a machining area 48. A workpiece is machined within the machining area 48.

The cover 30 is further equipped with a non-illustrated door and a non-illustrated window. The operator can carry out an introduction operation of the workpiece into the machining area 48 through the door that is in an opened state. Further, the operator can easily confirm the condition within the machining area 48 via the window.

The coolant supply device 32 is a device that supplies the coolant to the machining area 48. The coolant supply device 32 is equipped with a coolant tank 50, a nozzle 52, a supply pipe 54, and a pump 56.

The coolant tank 50 stores the coolant. The coolant tank 50 is installed externally of the machining area 48.

The nozzle 52 is a discharge unit that discharges the coolant. The nozzle 52 is disposed within the machining area 48. Moreover, the coolant supply device 32 may be equipped with a plurality of the nozzles 52.

The supply pipe 54 is a pipe that connects the coolant tank 50 and the nozzle 52. Moreover, the coolant supply device 32 may be equipped with a plurality of the supply pipes 54. The number of the supply pipes 54 is determined, for example, in accordance with the number of the nozzles 52. The supply pipe 54 passes through the cover 30, and connects the coolant tank 50 and the nozzle 52.

The pump 56 is connected to the supply pipe 54. The pump 56 draws in the coolant within the coolant tank 50, and delivers the coolant to the nozzle 52. Consequently, the coolant is discharged from the nozzle 52 into the machining area 48. Moreover, the pump 56 is controlled by the control device 14.

The coolant that is discharged into the machining area 48 cools the tool 16 and the workpiece. When machining is carried out in the machining area 48, a mist of the coolant is generated. There is a concern that the mist may leak out to the exterior of the machining area 48 via small gaps that occur in the machining device 12.

The mist collector 34 is a device that serves to collect the mist within the machining area 48. The mist collector 34 is installed externally of the machining area 48. Further, the mist collector 34 is connected to the cover 30 via a duct 58. The mist collector 34 collects the mist by drawing in air within the machining area 48. In accordance with this feature, the mist is prevented from leaking out to the exterior of the machining area 48.

By the tool 16 cutting the workpiece, fine or minute cutting chips are generated in the form of powdery dust within the machining area 48. There is a concern that the powdery dust, in the same manner as the mist, may leak out to the exterior of the machining area 48 via small gaps that occur in the machining device 12. The mist collector 34, by drawing in air within the machining area 48, may collect not only the mist, but also the powdery dust. In accordance with this feature, the powdery dust is prevented from leaking out to the exterior of the machining area 48.

The mist collector 34 may be connected to the coolant tank 50. Consequently, the mist that is collected by the mist collector 34 can be returned, as the coolant, to the coolant tank 50.

In the case that the mist collector 34 and the coolant tank 50 are connected to each other, it is preferable for the mist collector 34 and the coolant tank 50 to be connected to each other via a non-illustrated filtering device (filter). The filtering device removes impurities from the coolant that is delivered from the mist collector 34 to the coolant tank 50. By connecting the mist collector 34 and the coolant tank 50 via the filtering device, a clean coolant can be returned from the mist collector 34 to the coolant tank 50. Impurities in the coolant, for example, are the cutting chips that have been collected together with the mist.

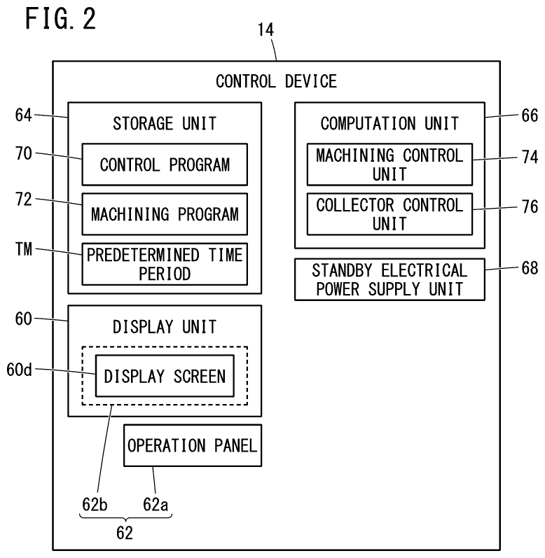

FIG. 2 is a block diagram of the control device 14.

The control device 14 is a computer that controls the machining device 12. The control device 14, for example, is a numerical control device. The control device 14 is equipped with a display unit 60, an operation unit 62, a storage unit 64, a computation unit 66, and a standby electrical power supply unit 68.

The display unit 60 is a display device equipped with a display screen 60d. The display unit 60, for example, is a liquid crystal display device or an OEL (Organic Electro-Luminescence) display device.

The operation unit 62 is an input device that receives instructions from the operator to the control device 14. The operation unit 62 includes, for example, an operation panel 62a, and a touch panel 62b or the like. The touch panel 62b is provided on the display screen 60d. The operation unit 62 (the operation panel 62a) may be equipped with a keyboard, a mouse, or the like.

The storage unit 64 is constituted by a non-illustrated volatile memory, and a non-illustrated nonvolatile memory. As an example of the volatile memory, there may be cited a random access memory (RAM) or the like. As an example of the nonvolatile memory, there may be cited a ROM (Read Only Memory) and a flash memory or the like. Data and the like may be stored, for example, in the volatile memory. A program, a data table, a map and the like may be stored, for example, in the nonvolatile memory. At least a portion of the storage unit 64 may be provided in the aforementioned processor, an integrated circuit, or the like. The storage unit 64 stores a control program 70 and a machining program 72.

The control program 70 is a program for the purpose of causing the control device 14 to execute the control method according to the present embodiment. The control method will be described in more detail later.

The machining program 72 is a program including control commands for the machining device 12. The machining program 72 includes, for example, a plurality of control commands for the purpose of controlling each of the aforementioned motors. Further, the machining program 72 also includes, for example, a plurality of control commands for the purpose of controlling the coolant supply device 32. The machining program 72 is created or edited in advance by the operator.

The computation unit 66 is constituted by a processor including, for example, a CPU (Central Processing Unit), and a GPU (Graphics Processing Unit) or the like. More specifically, the computation unit 66 can be constituted by a processing circuit (Processing Circuitry).

The computation unit 66 is equipped with a machining control unit 74 and a collector control unit 76. The machining control unit 74 and the collector control unit 76 are realized by the computation unit 66 executing the control program 70. Moreover, at least a portion of the machining control unit 74 and the collector control unit 76 may be realized by an integrated circuit such as an ASIC (Application Specific Integrated Circuit), an FPGA (Field-Programmable Gate Array), or the like. At least a portion of the machining control unit 74 and the collector control unit 76 may be configured by an electronic circuit including a discrete device.

The machining control unit 74, by controlling the machining device 12 based on the machining program 72, carries out machining on the workpiece. For example, based on the machining program 72, the machining control unit 74 controls the rotation of the spindle 18, the movement of the spindle head 20, and the movement of the table 26. However, within the machining device 12, the mist collector 34 is controlled by the collector control unit 76.

Further, the machining control unit 74 determines whether or not the coolant is to be used in the machining performed by the machining device 12 before the cutting of the workpiece is started. Such a determination is made based on the machining program 72, or alternatively, an instruction from the operator.

For example, the machining program 72 includes a control command for starting the coolant supply device 32. In this case, the machining control unit 74 determines that the coolant is to be used in the machining performed by the machining device 12. Further, for example, even if the machining program 72 does not include the control command for starting the coolant supply device 32, the operator may issue an instruction to the control device 14 to start the coolant supply device 32. In this case, the machining control unit 74 determines that the coolant is to be used in the machining performed by the machining device 12.

Furthermore, after the machining has been started, the machining control unit 74 determines whether or not the machining is completed based on the machining program 72. For example, in the case that all of the control commands necessary in order to machine the workpiece have been executed, the machining control unit 74 determines that the machining based on the machining program 72 is completed.

The collector control unit 76 determines whether or not to automatically start the mist collector 34, based on the result of determination (determination result) as to whether or not the coolant is to be used in the machining performed by the machining device 12.

For example, in the case that the coolant is not used in the machining performed by the machining device 12, the collector control unit 76 does not cause the mist collector 34 to be automatically started. In accordance with this feature, the mist collector 34 is prevented from being operated unnecessarily in the case that the mist is not generated. Therefore, the electrical power consumption of the mist collector 34 is suppressed.

On the other hand, in the case that the coolant is used in the machining performed by the machining device 12, the collector control unit 76 controls the mist collector 34 to cause the mist collector 34 to be automatically started. In accordance with this feature, it is possible for the mist that is generated within the machining area 48 during machining to be collected by the mist collector 34. In addition, the mist collector 34 is automatically started. Accordingly, the mist is prevented from leaking out to the exterior of the machining area 48 due to human error.

Moreover, even in the case it was understood that the coolant is to be used in the machining process performed by the machining device 12, it is preferable for the collector control unit 76 not to start the mist collector 34 until the machining is started. Stated otherwise, it is preferable for the collector control unit 76 to start the mist collector 34 in accordance with the machining being started. In accordance with this feature, the mist collector 34 is prevented from consuming electrical power prior to the mist being generated. In this case, the collector control unit 76 automatically starts the mist collector 34 in the case that, for example, an instruction is issued from the operator to the control device 14 to initiate the machining. The collector control unit 76 may automatically start the mist collector 34 in the case that an instruction has been issued from the operator to the control device 14 to start the coolant supply device 32.

Further, the collector control unit 76 determines whether or not to automatically stop the mist collector 34 based on the determination result as to whether or not the machining based on the machining program 72 is completed. In the case that the mist collector 34 is started, and further, the machining based on the machining program 72 is completed, the collector control unit 76 causes the mist collector 34 to be automatically stopped. In accordance with this feature, the mist collector 34 is prevented from being operated excessively after the machining is completed, for example, due to human error.

Moreover, it is preferable for the collector control unit 76 to cause the mist collector 34 to be stopped after a predetermined time period TM has elapsed from the completion of the machining. By continuing to allow the mist collector 34 to be operated even after the completion of the machining, it is possible to prevent a loss in the collection of the mist. Since the mist collector 34 is automatically stopped in the case that the predetermined time period TM has elapsed from the completion of the machining, the electrical power consumption of the mist collector 34 is prevented from becoming excessively large.

The start timing of the predetermined time period TM is a point in time at which the machining control unit 74 has determined that the machining is completed based on the machining program 72. However, the collector control unit 76 may calculate (estimate), based on the machining program 72, the end timing of the machining based on the machining program 72. In that case, the collector control unit 76 may use the calculated end timing as the start timing of the predetermined time period TM. Information indicating the predetermined time period TM is set in the control device 14, for example, by the operator. However, the information indicating the predetermined time period TM may also be set in the control device 14 by the manufacturer of the control device 14.

The standby electrical power supply unit 68 is an electrical power supply that is separate from the main power supply of the control device 14. The standby electrical power supply unit 68 includes, for example, a battery. The standby electrical power supply unit 68 is integrated in the control device 14. However, the standby electrical power supply unit 68 may be provided in the machine tool 10 as an external power supply for the control device 14. Moreover, it should be noted that the main power supply for the control device 14 is not shown in the drawings.

In the case that the main power supply of the control device 14 is turned OFF while the mist collector 34 is in operation, the standby electrical power supply unit 68 supplies electrical power to each of the components of the control device 14. In accordance with this feature, even after the main power supply has been turned OFF, the collector control unit 76 can continue to control the mist collector 34. Therefore, for example, even after the main power supply has been turned OFF, it is possible for the collector control unit 76 to cause the mist collector 34 to be automatically stopped.

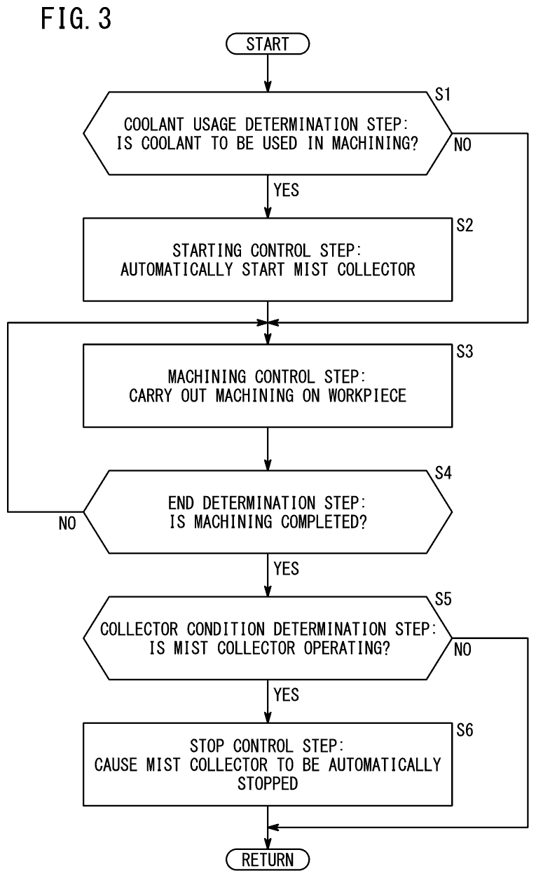

FIG. 3 is a flowchart illustrating the control method according to the embodiment.

The control device 14 executes a control method, for example, as illustrated in FIG. 3. The control device 14 executes the control method of FIG. 3, for example, in the case that the machining is started. Moreover, at the starting time of the control method, the mist collector 34 is stopped. The control method of FIG. 3 includes a coolant usage determination step S1, a starting control step S2, a machining control step S3, an end determination step S4, a collector condition determination step S5, and a stop control step S6.

In the coolant usage determination step S1, the machining control unit 74 determines whether or not the coolant is to be used in the machining performed by the machining device 12. As noted previously, the machining control unit 74 determines whether or not the coolant is to be used in the machining performed by the machining device 12, based on the machining program 72 or an instruction from the operator.

In the case that the coolant is to be used in the machining performed by the machining device 12 (step S1: YES), the starting control step S2 is initiated. In the starting control step S2, the collector control unit 76 controls the mist collector 34 to cause the mist collector 34 to be automatically started.

Moreover, in the case that the coolant is not to be used in the machining performed by the machining device 12 (step S1: NO), the starting control step S2 is skipped.

In the machining control step S3, the machining control unit 74 controls the machining device 12, and thereby carries out machining on the workpiece. The machining control unit 74 controls the machining device 12 on the basis of the machining program 72. In the case that the coolant is to be used in the machining control step S3, the mist is generated within the machining area 48. However, the mist is collected in the mist collector 34, and therefore, the mist does not leak out to the exterior of the machining area 48.

In the end determination step S4, the machining control unit 74 determines whether or not the machining based on the machining program 72 is completed. In the case that the machining is completed (step S4: YES), the collector condition determination step S5 is initiated. In the case that the machining is not completed (step S4: NO), the machining control step S3 is continued.

In the collector condition determination step S5, the collector control unit 76 determines whether or not the mist collector 34 is operating. In the case that the mist collector 34 is operating (step S5: YES), the stop control step S6 is initiated.

In the stop control step S6, the collector control unit 76 causes the mist collector 34 to be stopped. In the stop control step S6, although the collector control unit 76 may cause the mist collector 34 to be stopped immediately, it is preferable to cause the mist collector 34 to be stopped after the predetermined time period TM has elapsed from the completion of the machining.

Upon the stop control step S6 being completed, the control method of FIG. 3 is brought to an end. Moreover, in the case that the mist collector 34 is not operating (step S5: NO), the stop control step S6 is skipped. In that case, the control method of FIG. 3 comes to an end due to the collector condition determination step S5 being completed.

### Exemplary Modifications

Hereinafter, a description will be given concerning exemplary modifications of the above-described embodiment. However, any descriptions that are duplicative or overlap with those of the above-described embodiment will be appropriately omitted in the following description. Unless otherwise specified, the same reference numerals as in the above-described embodiment are used in referring to the elements that have already been described in the embodiment.

### Exemplary Modification 1

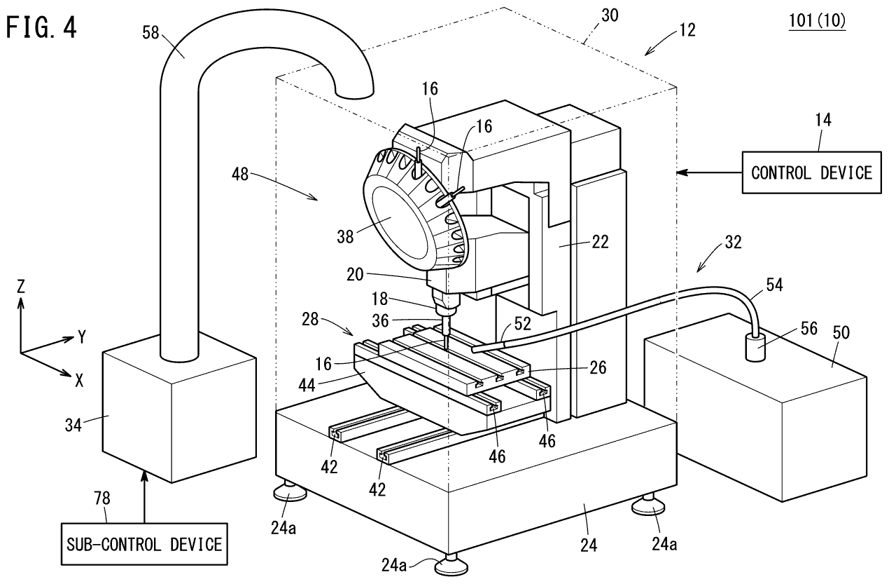

FIG. 4 is a schematic diagram of a machine tool 101 (10) according to an exemplary modification 1.

The machine tool 101 is further equipped with a sub-control device 78.

The sub-control device 78 is a computer that is separate from the control device 14. The sub-control device 78, for example, is equipped with a processor and a memory. The sub-control device 78 may also be equipped with an integrated circuit, a discrete device, or the like.

In the case that the control device 14 is stopped, the sub-control device 78 controls the mist collector 34 instead of the collector control unit 76. Accordingly, even in the case that the control device 14 is stopped, the mist collector 34 is controlled by the sub-control device 78 in the same manner as in the embodiment.

For example, in the case that the machining is completed, the operator issues an instruction to the control device 14 to immediately stop the machining. Consequently, the control device 14 immediately stops the machining after the completion of the machining. However, as noted previously, it is preferable for the mist collector 34 to collect the mist until the predetermined time period TM has elapsed from the completion of the machining. In such a case, the sub-control device 78 is capable of controlling the mist collector 34 instead of the control device 14.

Moreover, it is preferable for the sub-control device 78 and the control device 14 to communicate with each other as appropriate, and to share the data necessary for controlling the mist collector 34. For example, the sub-control device 78 and the control device 14 share various information concerning the necessity/unnecessity of the coolant during the machining, the progress of the machining, and further, the time period that has elapsed from the completion of the machining. In accordance with these features, the sub-control device 78 is capable of smoothly taking over the control that was being performed by the collector control unit 76. According to the present exemplary modification, even after the control device 14 is stopped, the control of the mist collector 34 can be continued by the sub-control device 78.

### Exemplary Modification 2

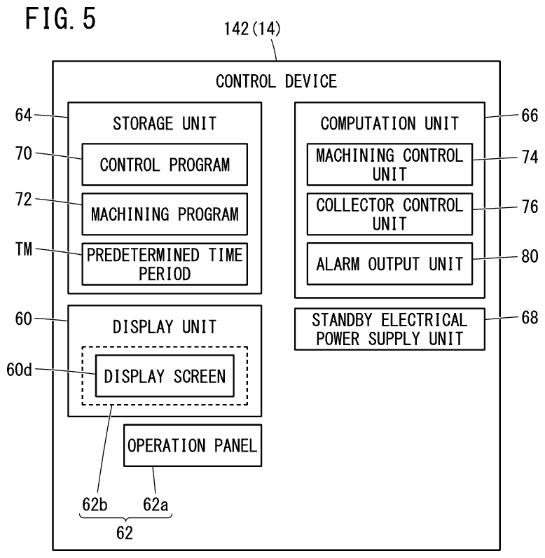

FIG. 5 is a block diagram of a control device 142 (14) according to an exemplary modification 2.

The control device 142 is further equipped with an alarm output unit 80.

The alarm output unit 80 outputs an alarm in the case that an abnormality has occurred in the machine tool 10. For example, the machine tool 10 is appropriately provided with non-illustrated sensors for the purpose of detecting malfunctions or troubles in each of the respective components such as the spindle 18, the spindle head 20, the table drive unit 28, etc. The alarm output unit 80 determines whether or not a malfunction has occurred in the machine tool 10 based on the signals output by the sensors. In the case that a malfunction is detected in any of the respective components of the machine tool 10, the alarm output unit 80 issues a notification to the operator, for example via the display unit 60, to the effect that a malfunction has occurred.

In the case that the alarm output unit 80 has output an alarm prior to the start of the machining, the machining control unit 74 does not start the machining until the cause of the alarm is eliminated. Further, in the case that the alarm output unit 80 has output an alarm after the start of the machining, the machining control unit 74 suspends the machining based on the machining program 72 until the cause of the alarm is eliminated.

In the case that the alarm output unit 80 has output an alarm, the collector control unit 76 prohibits the operation of the mist collector 34 until the cause of the alarm is eliminated. In the case that the mist collector 34 is in operation at the point in time when the alarm is output, then regardless of the machining program 72 and the instruction of the operator, the collector control unit 76 causes the mist collector 34 to be stopped.

According to the present exemplary modification, in the case that an abnormality has occurred in the machine tool 10, the mist collector 34 is prevented from operating.

### Combination of Plural Exemplary Modifications

The above-described plurality of exemplary modifications may be combined as appropriate within a range in which there are no contradictions therebetween.

### Modified Embodiments

It should be noted that the present invention is not limited to the embodiment described above, and various alternative or additional configurations may be adopted therein without departing from the essence and gist of the present invention.

For example, in the above-described embodiment, whether or not the mist collector 34 should be started is determined prior to the start of the machining, based on whether or not the coolant is to be used in the machining. However, the collector control unit 76 may determine whether or not to cause the mist collector 34 to be started after the machining has been started. In that case, the collector control unit 76 acquires the information indicating the discharge time period during the machining. The discharge time period is the time period during which the coolant is discharged into the machining area 48 during the machining. The information indicating the discharge time period is acquired, for example, using a timer. The collector control unit 76 may also acquire the information indicating a discharge amount. The discharge amount is the amount of liquid of the coolant that is discharged into the machining area 48 during the machining. The information indicating the discharge amount is acquired, for example, using a flow rate sensor.

In the case of acquiring the discharge time period or the discharge amount, the collector control unit 76 determines whether or not to cause the mist collector 34 to be started based on the discharge time period or the discharge amount. For example, in the case that the discharge time period or the discharge amount is of a small value, then even if the coolant is discharged into the machining area 48, almost no mist is generated. Accordingly, in the case that the discharge time period or the discharge amount is of a small value, any risk that the mist will leak out to the exterior of the machining area 48 is small. On the other hand, after the discharge time period or the discharge amount has reached a large value of a certain degree, the risk of the mist leaking out to the exterior of the machining area 48 increases. In consideration of the foregoing, in the case that the discharge time period or the discharge amount is less than or equal to the predetermined threshold value, the collector control unit 76 prohibits the mist collector 34 from being operated. Consequently, the mist collector 34 is prevented from needlessly consuming electrical power. Furthermore, in the case that the discharge time period or the discharge amount has exceeded the predetermined threshold value, the collector control unit 76 controls the mist collector 34, and thereby automatically causes the mist collector 34 to be started. In accordance with this feature, the mist is prevented from leaking out to the exterior of the machining area 48. The threshold value is specified in advance by the operator or the manufacturer of the machine tool 10.

In the case that the discharge time period or the discharge amount is acquired, the collector control unit 76 may change the length of the predetermined time period TM depending on the discharge time period or the discharge amount. For example, the greater the value of the discharge time period or the discharge amount, the greater the amount of the mist that is generated. In consideration thereof, the collector control unit 76 may set the predetermined time period TM to be longer as the value of the discharge time period or the discharge amount becomes greater. In accordance with this feature, it is possible to more reliably reduce the loss in the collection of the mist. On the other hand, the collector control unit 76 may set the predetermined time period TM to be shorter as the value of the discharge time period or the discharge amount becomes smaller. In accordance with this feature, it is possible to suppress the electrical power consumption of the mist collector 34. The collector control unit 76 may determine the length of the predetermined time period TM using a data table in which a plurality of the predetermined time periods TM are stored in accordance with the discharge time period or the discharge amount.

The collector control unit 76 may calculate (or predict), based on the machining program 72, the arrival timing at which the discharge time period or the discharge amount reaches the threshold value. Further, the collector control unit 76 may calculate the aforementioned arrival timing using not only the machining program 72, but also various parameters that have been set in the control device 14 related to the machining. The collector control unit 76 may use the calculated arrival timing as the timing at which the mist collector 34 is started.

The coolant discharge method is not limited to being that of the embodiment. For example, the coolant may be discharged using a center-through method. In that case, the coolant supply device 32 supplies the coolant to the spindle 18. Further, the coolant may flow along the inner wall of the cover 30 (the machining area 48).

The machining device 12 may further be equipped with a non-illustrated recovery member in order to recover the coolant that falls downwardly of the table 26. Such a recovery member, for example, is an oil pan provided on the pedestal 24. A portion of the coolant supplied to the machining area 48 falls downwardly of the table 26 without turning into a mist. According to the present exemplary modification, it is possible to collect the coolant that has fallen downwardly of the table 26. The recovered coolant may be returned to the coolant tank 50. In accordance with this feature, the coolant supply device 32 is capable of reusing the coolant that has been collected. In this instance, it is preferable for a filtering device (a filter) to be disposed between the recovery member and the coolant tank 50. In accordance with this feature, a clean coolant can be returned to the coolant tank 50.

In the machining program 72, there may be included a control command to cause the mist collector 34 to be started. In that case, the collector control unit 76 causes the mist collector 34 to be started based on the control command to cause the mist collector 34 to be started. In the machining program 72, there may be included a control command to cause the mist collector 34 to be stopped. In that case, the collector control unit 76 causes the mist collector 34 to be stopped based on the control command to cause the mist collector 34 to be stopped.

### Invention That Can Be Understood from the Embodiments

The invention that can be grasped from the above embodiment and modifications are described below.

### <First Aspect of Invention>

The first aspect of invention is the control device (14) for the machine tool (10) including the coolant supply device (32) configured to supply the coolant to the machining area (48), and the mist collector (34) configured to collect the mist within the machining area, the machine tool being configured to machine the workpiece within the machining area, the control device including the machining control unit (74) configured to control the machine tool to carry out machining based on the machining program (72), and configured to determine whether or not the machining is completed, and the collector control unit (76) configured to automatically stop the mist collector in the case that the machining is completed.

In accordance with such features, it is possible to suppress the electrical power consumption of the mist collector.

In the above-described control device, in the case that the coolant is used in the machining, the collector control unit may automatically start the mist collector, and thereby cause the mist to be collected. In accordance with this feature, the mist is prevented from leaking out to the exterior of the machining area.

In the above-described control device, in the case that the coolant is used in the machining, the collector control unit may cause the mist collector to be stopped after the predetermined time period (TM) has elapsed from the completion of the machining. In accordance with this feature, the amount of the mist that remains in the machining area after the completion of the machining is reduced, while the electrical power consumption of the mist collector is prevented from becoming excessively large.

In the above-described control device, the machining control unit may determine whether or not the coolant is used in the machining based on the machining program or the instruction from the operator, and the collector control unit may control the mist collector based on the result of determination by the machining control unit. In accordance with this feature, the mist collector is controlled automatically.

In the above-described machining control unit, the control device may further include the alarm output unit (80) configured to output the alarm in the case that the abnormality has occurred in the machine tool, wherein, in the case that the alarm output unit has output the alarm, the collector control unit may prohibit the operation of the mist collector. In accordance with this feature, the mist collector is prevented from operating in the case that an abnormality has occurred in the machine tool.

### <Second Aspect of Invention>

The second aspect of invention is the machine tool (10) including the control device according to the first aspect of invention.

In accordance with this feature, it is possible to suppress an increase in the amount of electrical power consumption by the machine tool.

The above-described machine tool may further be equipped with the sub-control device (78) configured to control the mist collector instead of the collector control unit in the case that the control device is stopped. In accordance with this feature, even in the case that the control device is stopped, an automated control of the mist collector is carried out.

### <Third Aspect of Invention>

The third aspect of invention is the control method for controlling by the computer (14) the machine tool (10) including the coolant supply device (32) configured to supply the coolant to the machining area (48), and the mist collector (34) configured to collect the mist within the machining area, the machine tool being configured to machine the workpiece within the machining area, the control method including the end determination step (step S4) in which the computer determines whether or not machining is completed based on the machining program (72), and the stop control step (step S6) in which the computer controls the mist collector, and causes the mist collector to be automatically stopped in the case that the machining is completed.

In accordance with such features, it is possible to suppress an increase in the amount of electrical power consumption by the mist collector.

### REFERENCE SIGNS LIST

10, 101: machine tool
12: machining device
14, 142: control device
32: coolant supply device
34: mist collector
48: machining area
72: machining program
74: machining control unit
76: collector control unit
78: sub-control device
80: alarm output unit
TM: predetermined time period

1. A control device for a machine tool comprising a coolant supply device configured to supply a coolant to a machining area, and a mist collector configured to collect mist within the machining area, the machine tool being configured to machine a workpiece within the machining area, the control device comprising:
a machining control unit configured to control the machine tool to carry out machining based on a machining program, and configured to determine whether or not the machining is completed; and
a collector control unit configured to automatically stop the mist collector in a case that the machining is completed.

2. The control device according to claim 1, wherein, in a case that the coolant is used in the machining, the collector control unit automatically starts the mist collector, and thereby causes the mist to be collected.

3. The control device according to claim 1, wherein, in a case that the coolant is used in the machining, the collector control unit causes the mist collector to be stopped after a predetermined time period has elapsed from completion of the machining.

4. The control device according to claim 2, wherein the machining control unit determines whether or not the coolant is used in the machining based on the machining program or an instruction from an operator, and
the collector control unit controls the mist collector based on a result of determination by the machining control unit.

5. The control device according to claim 1, further comprising an alarm output unit configured to output an alarm in a case that an abnormality has occurred in the machine tool,
wherein, in a case that the alarm output unit has output the alarm, the collector control unit prohibits an operation of the mist collector.

6. A machine tool comprising the control device according to claim 1.

7. The machine tool according to claim 6, wherein the machine tool further comprises a sub-control device configured to control the mist collector instead of the collector control unit in a case that the control device is stopped.

8. A control method for controlling by a computer a machine tool comprising a coolant supply device configured to supply a coolant to a machining area, and a mist collector configured to collect mist within the machining area, the machine tool being configured to machine a workpiece within the machining area, the control method comprising:
an end determination step in which the computer determines whether or not machining is completed based on a machining program; and
a stop control step in which the computer controls the mist collector, and causes the mist collector to be automatically stopped in a case that the machining is completed.
